(19) United States
(12) Patent Application Publication
(10) Pub. No.: US 2026/0229407 A1
(43) Pub. Date: Aug. 6, 2026

(54) THIN FILM CAPACITOR AND CIRCUIT BOARD HAVING THE SAME

(71) Applicant: TDK Corporation, Tokyo (JP)

(72) Inventors: Hitoshi SAITA, Tokyo (JP); Rieki KAZAWA, Tokyo (JP)

(21) Appl. No.: 19/146,138

(22) PCT Filed: Oct. 17, 2023
(86) PCT No.: PCT/JP2023/037533

§ 371 Date: Jul. 7, 2025

Related U.S. Application Data
(60) Provisional application No. 63/479,080, filed on Jan. 9, 2023.

(51) Int. Cl. H01G 4/005; H01G 4/228; H01G 4/33

(52) U.S. Cl. CPC H01G 4/005; H01G 4/228; H01G 4/33

(57) ABSTRACT

Please replace the abstract with the following:

To provide a thin film capacitor capable of reducing a connection resistance between a terminal electrode and a capacitance electrode. A thin film capacitor includes: unit capacitors to stacked to one another through an insulating layer; and via conductors. The unit capacitor includes: a capacitance electrode and a dummy electrode which are provided on one surface of a dielectric layer and a capacitance electrode and a dummy electrode which are provided on the other surface of the dielectric layer. The via conductor penetrates a stacked body so as to contact dummy electrodes, and capacitance electrodes. The via conductor penetrates the stacked body so as to contact dummy electrodes, and capacitance electrodes.

### CROSS-REFERENCE TO RELATED APPLICATIONS

This application is the U.S. National Phase under 35 U. S. C. § 371 of International Application No. PCT/JP 2023/037533, filed on Oct. 17, 2023, which claims the benefit of priority to U.S. Provisional Patent Application No. 63/479,080 filed on Jan. 9, 2023, the entire contents of each of which are hereby incorporated by reference.

### TECHNICAL FIELD

The present disclosure relates to a thin film capacitor and a circuit board having the same.

### BACKGROUND ART

Patent Document 1 discloses a stacked type thin film capacitor obtained by stacking a plurality of thin film capacitors one on another.

### CITATION LIST

### Patent Document

[Patent Document 1] JP 2019-140312A

### DISCLOSURE OF THE INVENTION

### Problem to be Solved by the Invention

The thin film capacitor described in Patent Document 1 has a structure in which a terminal electrode contacts the side surface of a capacitance electrode.

The present disclosure describes a thin film

capacitor capable of reducing a connection resistance between the terminal electrode and the capacitance electrode.

### Means for Solving the Problem

A thin film capacitor according to an aspect of the present disclosure includes: a plurality of unit capacitors stacked to one another through a first insulating layer; and first and second via conductors. Each of the plurality of unit capacitors includes a dielectric layer having opposing first and second surfaces, a first capacitance electrode and a first dummy electrode which are provided on the first surface of the dielectric layer, and a second capacitance electrode and a second dummy electrode which are provided on the second surface of the dielectric layer. The first capacitance electrode overlaps with the second capacitance electrode and the second dummy electrode. The second capacitance electrode overlaps with the first capacitance electrode and the first dummy electrode. The first via conductor penetrates the plurality of unit capacitors and the first insulating layer so as to contact the first capacitance electrode and the second dummy electrode included in each of the plurality of unit capacitors, and the second via conductor penetrates the plurality of unit capacitors and the first insulating layer so as to contact the second capacitance electrode and the first dummy electrode included in each of the plurality of unit capacitors.

### Advantageous Effects of the Invention

According to the present disclosure, a thin film capacitor capable of reducing a connection resistance between the terminal electrode and the capacitance electrode is provided.

### BRIEF DESCRIPTION OF THE DRAWINGS

FIG. 1A is a schematic top view of a thin film capacitor 1 according to a first embodiment of the technology described herein as viewed from the upper surface side. FIG. 1B is a schematic cross-sectional view of the thin film capacitor 1. FIG. 1C is a schematic bottom view of the thin film capacitor 1 as viewed from the lower surface side.

FIGS. 2A to 2D are process views for explaining a manufacturing method for the thin film capacitor 1 according to the first embodiment.

FIGS. 3A to 3C are process views for explaining a manufacturing method for the thin film capacitor 1 according to the first embodiment.

FIG. 4 is a schematic cross-sectional view of a thin film capacitor 1A according to a first modification of the first embodiment.

FIG. 5 is a schematic cross-sectional view of a thin film capacitor 1B according to a second modification of the first embodiment.

FIG. 6A is a schematic cross-sectional view of a thin film capacitor 1C according to a third modification of the first embodiment. FIG. 6B is a schematic diagram illustrating an example in which solders 25 and 26 are provided on a thin film capacitor 1C.

FIG. 7A is a schematic top view of a thin film capacitor 2 according to a second embodiment of the technology described herein as viewed from the upper surface side. FIG. 7B is a schematic cross-sectional view of the thin film capacitor 2. FIG. 7C is a schematic bottom view of the thin film capacitor 2 as viewed from the lower surface side.

FIGS. 8A to 8D are process views for explaining a manufacturing method for the thin film capacitor 2 according to the second embodiment.

FIGS. 9A to 9D are process views for explaining a manufacturing method for thin film capacitor 2 according to the second embodiment.

FIG. 10A is a schematic top view of a thin film capacitor 3 according to a third embodiment of the technology described herein as viewed from the upper surface side. FIG. 10B is a schematic cross-sectional view of the thin film capacitor 3. FIG. 10C is a schematic bottom view of the thin film capacitor 3 as viewed from the lower surface side.

FIG. 11 is a schematic cross-sectional view of a thin film capacitor 4 according to a fourth embodiment of the technology described herein.

FIGS. 12A and 12B are views for explaining the structure of the unit capacitor C1 according to a first example. FIG. 12A is a schematic top view illustrating the planar shapes of the capacitance electrode 111 and the dummy electrode 112. FIG. 12B is a schematic transparent top view of the planar shapes of the capacitance electrode 121 and the dummy electrode 122 as viewed from the upper surface side.

FIGS. 13A and 13B are views for explaining the structure of the unit capacitor C1 according to a second example. FIG. 13A is a schematic top view illustrating the planar shapes of the capacitance electrode 111 and the dummy electrode 112. FIG. 13B is a schematic transparent top view of the planar shapes of the capacitance electrode 121 and the dummy electrode 122 as viewed from the upper surface side.

FIGS. 14A and 14B are views for explaining the structure of the unit capacitor C1 according to a third example. FIG. 14A is a schematic top view illustrating the planar shapes of the capacitance electrode 111 and the dummy electrode 112. FIG. 14B is a schematic transparent top view of the planar shapes of the capacitance electrode 121 and the dummy electrode 122 as viewed from the upper surface side.

FIGS. 15A and 15B are views for explaining the structure of the unit capacitor C1 according to a fourth example. FIG. 15A is a schematic top view illustrating the planar shapes of the capacitance electrode 111 and the dummy electrode 112. FIG. 15B is a schematic transparent top view of the planar shapes of the capacitance electrode 121 and the dummy electrode 122 as viewed from the upper surface side.

FIGS. 16A and 16B are views for explaining the structure of the unit capacitor C1 according to a fifth example. FIG. 16A is a schematic top view illustrating the planar shapes of the capacitance electrode 111 and the dummy electrode 112. FIG. 16B is a schematic transparent top view of the planar shapes of the capacitance electrode 121 and the dummy electrode 122 as viewed from the upper surface side.

FIGS. 17A and 17B are views for explaining the structure of the unit capacitor C1 according to a sixth example. FIG. 17A is a schematic top view illustrating the planar shapes of the capacitance electrode 111 and the dummy electrode 112. FIG. 17B is a schematic transparent top view of the planar shapes of the capacitance electrode 121 and the dummy electrode 122 as viewed from the upper surface side.

FIG. 18A is a schematic cross-sectional view for explaining the structure of a circuit board 6 having the thin film capacitor 1 according to the first embodiment. FIG. 18B is a schematic cross-sectional view for explaining the structure of a circuit board 6A having the thin film capacitor 1 according to the first embodiment.

FIG. 19A is a schematic cross-sectional view for explaining the structure of a circuit board 6B having the thin film capacitor 1 according to the first embodiment. FIG. 19B is a schematic cross-sectional view for explaining the structure of a circuit board 6C having the thin film capacitor 1 according to the first embodiment.

### MODE FOR CARRYING OUT THE INVENTION

Hereinafter, preferred embodiments of the present invention will be described in detail with reference to the accompanying drawings.

### First Embodiment

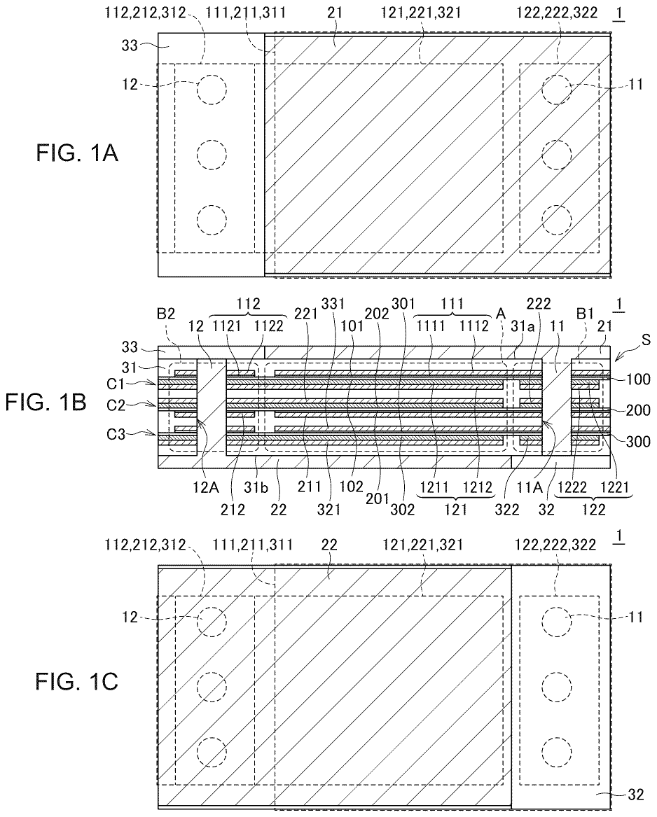

FIG. 1A is a schematic top view of a thin film capacitor 1 according to a first embodiment Of the technology described herein as viewed from the upper surface side. FIG. 1B is a schematic cross-sectional view of the thin film capacitor 1. FIG. 1C is a schematic bottom view of the thin film capacitor 1 as viewed from the lower surface side.

As illustrated in FIGS. 1A to 1C, the thin film capacitor 1 according to the first embodiment has a structure in which three unit capacitors C1 to C3 are stacked to one another through an insulating layer 31. A terminal electrode 21 is provided on one surface 31a in the stacking direction of a stacked body S composed of the insulating layer 31 and unit capacitors C1 to C3. A terminal electrode 22 is provided on the other surface 31b in the stacking direction of the stacked body S. The insulating layer 31 is made of a resin material and may contain a core material such as glass cloth.

The unit capacitors C1 to C3 have the same structure. The unit capacitor C1 includes a dielectric layer 100, a capacitance electrode 111 provided on one surface 101 of the dielectric layer 100, and a capacitance electrode 121 provided on the other surface 102 of the dielectric layer 100. The capacitance electrode 111 may be a stacked body composed of a lower layer conductor 1111 contacting the dielectric layer 100 and made of, for example, nickel (Ni), copper (Cu), or rare earth metal and an upper layer conductor 1112 stacked on the lower layer conductor 1111 and made of a different material from the material of the lower layer conductor 1111 which is selected from the group consisting of, for example, nickel (Ni), copper (Cu), or rare earth metal. The capacitance electrode 111 is sometimes referred to as an upper electrode. The capacitance electrode 121 may be a stacked body composed of a lower layer conductor 1211 contacting the dielectric layer 100 and made of, for example, nickel (Ni), a nickel alloy, or copper and an upper layer conductor 1212 stacked on the lower layer conductor 1211 and made of a different material from the material of the lower layer conductor 1211 which is, for example, copper (Cu). The capacitance electrode 121 is sometimes referred to as a lower electrode.

Similarly, the unit capacitor C2 includes a dielectric layer 200, a capacitance electrode 211 provided on one surface 201 of the dielectric layer 200, and a capacitance electrode 221 provided on the other surface 202 of the dielectric layer 200. The unit capacitor C3 includes a dielectric layer 300, a capacitance electrode 311 provided on one surface 301 of the dielectric layer 300, and a capacitance electrode 321 provided on the other surface 302 of the dielectric layer 300. The capacitance electrodes 211 and 311 may be made of the same material and have the same layer configuration as the capacitance electrode 111. The capacitance electrodes 221 and 321 may be made of the same material and have the same layer configuration as the capacitance electrode 121.

The dielectric layers 100, 200, and 300 are constituted by a perovskite dielectric material, for example. Examples of the perovskite dielectric material include a ferroelectric material or a paraelectric material having a perovskite structure, such as BaTio 3 (barium titanate), (Ba₁₋ₓSrₓ) TiO₃ (barium strontium titanate), (Ba₁₋ₓCaₓ)TiO₃, PbTiO₃, Pb(ZrₓTi₁₋ₓ)O₃, (Sr₁₋ₓCaₓ), (Ti_{1-Y}Zr_{Y})O₃, Ba(Mg_{1/3}Ta_{2/3}), a composite perovskite relaxer type ferroelectric material represented by Pb(Mg_{1/3}Nb_{2/3})O₃, and the like, a bismuth layer compound represented by Bi₄Ti₃O₁₂, and SrBi₂Ta₂O₉, a tungsten bronze type ferroelectric material represented by (Sr₁₋ₓBaₓ) Nb₂O₆ and PbNb₂O₆. Here, in the above-described perovskite structure, perovskite relaxer type ferroelectric material, bismuth layer compound, and tungsten bronze type ferroelectric material, the ratio of A site and B site is usually an integer ratio but may be purposefully shifted from the integer ratio in order to improve characteristics. In order to control the characteristics of the dielectric layers 100, 200, and 300, the dielectric layers 100, 200, and 300 may appropriately contain an additive substance as a subcomponent. The relative permittivity (Er) of the dielectric layers 100, 200, and 300 is 10 or more, for example. Further, the larger the dielectric withstand voltage of the dielectric layers 100, 200, and 300, the better, and there is not particular restriction on the upper limit value thereof. The larger the relative permittivity of the dielectric layers 100, 200, and 300, the better, and there is not particular restriction on the upper limit value thereof. The thickness of the dielectric layers 100, 200, and 300 is about 10 nm to about 6000 nm, for example.

There is provided, on the same layer as the capacitance electrode 111, a dummy electrode 112 made of the same material and having the same layer configuration as the capacitance electrode 111. The dummy electrode 112 is separated from the capacitance electrode 111 and is smaller in size than the capacitance electrode 111. The dummy electrode 112 may be a stacked body of a lower layer conductor 1121 and an upper layer conductor 1122. There is provided, on the same layer as the capacitance electrode 121, a dummy electrode 122 made of the same material and having the same layer configuration as the capacitance electrode 121. The dummy electrode 122 is separated from the capacitance electrode 121 and is smaller in size than the capacitance electrode 121. The dummy electrode 122 may be a stacked body of a lower layer conductor 1221 and an upper layer conductor 1222.

There is provided, on the same layer as the capacitance electrode 211, a dummy electrode 212 made of the same material and having the same layer configuration as the capacitance electrode 211. The dummy electrode 212 is separated from the capacitance electrode 211 and is smaller in size than the capacitance electrode 211. There is provided, on the same layer as the capacitance electrode 221, a dummy electrode 222 made of the same material and having the same layer configuration as the capacitance electrode 221. The dummy electrode 222 is separated from the capacitance electrode 221 and is smaller in size than the capacitance electrode 221.

There is provided, on the same layer as the capacitance electrode 311, a dummy electrode 312 made of the same material and having the same layer configuration as the capacitance electrode 311. The dummy electrode 312 is separated from the capacitance electrode 311 and is smaller in size than the capacitance electrode 311. There is provided, on the same layer as the capacitance electrode 321, a dummy electrode 322 made of the same material and having the same layer configuration as the capacitance electrode 321. The dummy electrode 322 is separated from the capacitance electrode 321 and is smaller in size than the capacitance electrode 321.

The unit capacitors C1 and C2 adjacent to each other in the stacking direction are arranged such that the capacitance electrodes 121 and 221 face each other through the insulating layer 31 and that the dummy electrodes 122 and 222 face each other through the insulating layer 31. The unit capacitors C2 and C3 adjacent to each other in the stacking direction are arranged such that the capacitance electrodes 211 and 311 face each other through the insulating layer 31 and that the dummy electrodes 212 and 312 face each other through the insulating layer 31.

The capacitance electrode 111 overlaps the capacitance electrode 121 and dummy electrode 122 through the dielectric layer 100. The capacitance electrode 121 overlaps the capacitance electrode 111 and dummy electrode 112 through the dielectric layer 100. The dummy electrodes 112 and 122 do not overlap each other.

The capacitance electrode 211 overlaps the capacitance electrode 221 and dummy electrode 222 through the dielectric layer 200. The capacitance electrode 221 overlaps the capacitance electrode 211 and dummy electrode 212 through the dielectric layer 200. The dummy electrodes 212 and 222 do not overlap each other.

The capacitance electrode 311 overlaps the capacitance electrode 321 and dummy electrode 322 through the dielectric layer 300. The capacitance electrode 321 overlaps the capacitance electrode 311 and dummy electrode 312 through the dielectric layer 300. The dummy electrodes 312 and 322 do not overlap each other.

The area where the capacitance electrodes 111 and 121 overlap each other, the area where e the capacitance electrode 211 and 221 overlap each other, and the area where the capacitance electrodes 311 and 321 overlap each other constitute an effective area A generating capacitance. In the present embodiment, the capacitance electrodes 111, 211, and 311 are larger in area than the capacitance electrodes 121, 221, and 321. Further, in a plan view, the capacitance electrodes 121, 221, and 321 overlap at three sides each thereof the capacitance electrodes 111, 211, and 311. Thus, the area of the effective area A depends significantly on the areas of the capacitance electrodes 121, 221, and 321.

The dummy electrodes 122, 222, 322 overlap one another in a plan view as viewed in the stacking direction. A via hole 11A is formed in the stacked body S composed of the insulating layer 31 and unit capacitors C1 to C3 so as to penetrate the dummy electrodes 122, 222, and 322 and capacitance electrodes 111, 211, and 311. The area where the dummy electrodes 122, 222 and 322 and capacitance electrodes 111, 211 and 311 overlap one another constitutes a dummy area B1 where capacitance is not generated. The via hole 11A is filled with a via conductor 11. Thus, the via conductor 11 contacts the dummy electrodes 122, 222, and 322 and capacitance electrodes 111, 211, and 311. Although the via hole 11A need not be completely filled with the via conductor 11, the via conductor 11 exists at least on the inner wall of the via hole 11A and at the center portion of the via hole 11A in the radial direction.

The dummy electrodes 112, 212, 312 overlap one another in a plan view as viewed in the stacking direction. A via hole 12A is formed in the stacked body S composed of the insulating layer 31 and unit capacitors C1 to C3 so as to penetrate the dummy electrodes 112, 212, and 312 and capacitance electrodes 121, 221, and 321. The area where the dummy electrodes 112, 212 and 312 and capacitance electrodes 121, 221 and 321 overlap one another constitutes a dummy area B2 where capacitance is not generated. The via hole 12A is filled with a via conductor 12. Thus, the via conductor 12 contacts the dummy electrodes 112, 212, and 312 and capacitance electrodes 121, 221, and 321. Although the via hole 12A need not be completely filled with the via conductor 12, the via conductor 12 exists at least on the inner wall of the via hole 12A and at the center portion of the via hole 12A in the radial direction.

One end portion of the via conductor 11 contacts the terminal electrode 21 provided on the surface 31a (one outer surface of the stacked body S) of the insulating layer 31. The terminal electrode 21 faces the capacitance electrode 111 through the insulating layer 31. An insulating layer 32 is provided on the surface 31b (the other outer surface of the stacked body S) of the insulating layer 31 so as to contact the other end portion of the via conductor 11. One end portion of the via conductor 12 contacts the terminal electrode 22 provided on the surface 31b (the other outer surface of the stacked body S) of the insulating layer 31. The terminal electrode 22 faces the capacitance electrode 321 through the insulating layer 31. An insulating layer 33 is provided on the surface 31a (one outer surface of the stacked body S) of the insulating layer 31 so as to contact the other end portion of the via conductor 12. The insulating layers 32 and 33 may be made of a resin material.

As a result, three unit capacitors C1 to C3 are connected in parallel between the terminal electrodes 21 and 22. As illustrated in FIGS. 1A and 1C, the via conductor 11 and 12 may each be provided in plural numbers. In this case, the plurality of via conductors 11 are connected in common to the terminal electrode 21, and the plurality of via conductors 12 are connected in common to the terminal electrode 22. When the via conductors 11 and 12 are thus each provided in plural numbers, it is possible to reduce connection resistances between the unit capacitors C1 to C3 and the terminal electrodes 21 and 22.

As described above, in the thin film capacitor 1 according to the present embodiment, the unit capacitors C1 to C3 each have the effective area A and dummy areas Bl and B2, and the via conductors 11 and 12 are formed so as to respectively penetrate the dummy area B1 and the dummy area B2. That is, the effective area A, having no via conductor, is unlikely to be damaged due to formation of the via holes 11A and 12A or formation of the via conductors 11 and 12. Further, external stress is hardly transmitted to the effective area A through the via conductors 11 and 12. Furthermore, the effective area A is positioned between the dummy areas B1 and B2 in a plan view, and hence enhances the moisture resistance of the effective area A, which increases product reliability.

In addition, the via conductors 11 and 12 are used to connect the terminal electrodes 21 and 22 and the unit capacitors C1 to C3, connection resistances between the terminal electrodes 21 and 22 and the unit capacitors C1 to C3 are also reduced. Further, in the present embodiment, the via holes 11A and 12A are filled respectively with the via conductors 11 and 12, so that resistance values of the via conductors 11 and 12 themselves are also reduced.

Further, in the present embodiment, the capacitance electrodes 121 and 221 both of which are connected to the terminal electrode 22 face each other through the insulating layer 31, and the capacitance electrodes 211 and 311 both of which are connected to the terminal electrode 21 face each other through the insulating layer 31, so that a high electric field is not applied to the insulating layer positioned between the capacitance electrodes adjacent to each other in the stacking direction. Furthermore, the capacitance electrode 111 connected to the terminal electrode 21 faces the terminal electrode 21 through the insulating layer 31, and the capacitance electrode 321 connected to the terminal electrode 22 faces the terminal electrode 22 through the insulating layer 31. This suppresses generation of a stray capacitance through the insulating layer 31 to achieve stable driving at a high frequency. The same applies to the dummy electrode. That is, the capacitance electrodes 122 and 222 both of which are connected to the terminal electrode 21 face each other through the insulating layer 31, and the capacitance electrodes 212 and 312 both of which are connected to the terminal electrode 22 face each other through the insulating layer 31, SO that generation of stray capacitance is suppressed.

Further, in the present embodiment, the capacitance electrodes 111, 211, and 311 are exposed at three sides each thereof from the insulating layer 31, and the capacitance electrodes 121, 221, and 321 are exposed at one side each thereof from the insulating layer 31. That is, the three sides of each of the capacitance electrodes 111, 211, and 311 and one side of each of the capacitance electrodes 121, 221, and 321 are exposed from the side surfaces of the stacked body S. As a result, heat generated inside the thin film capacitor 1 can be dissipated outside efficiently.

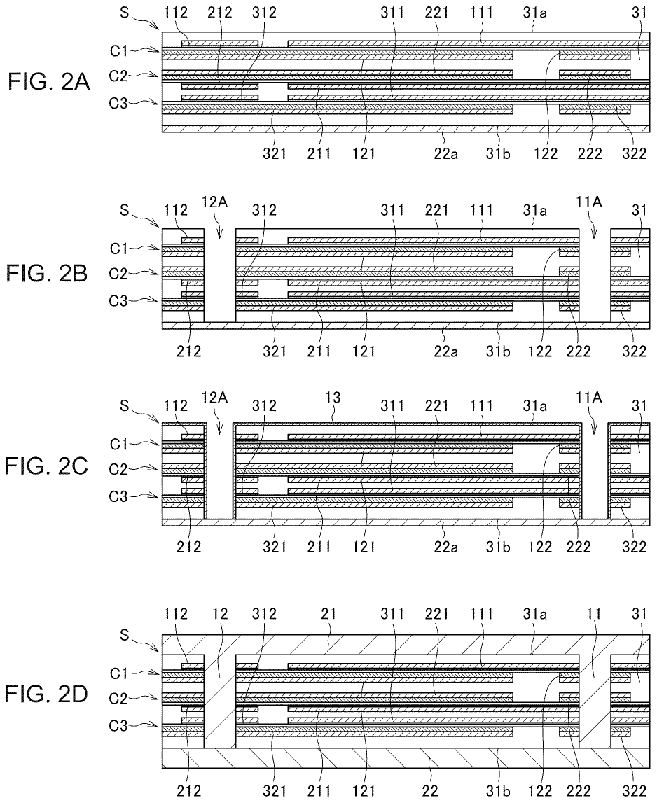

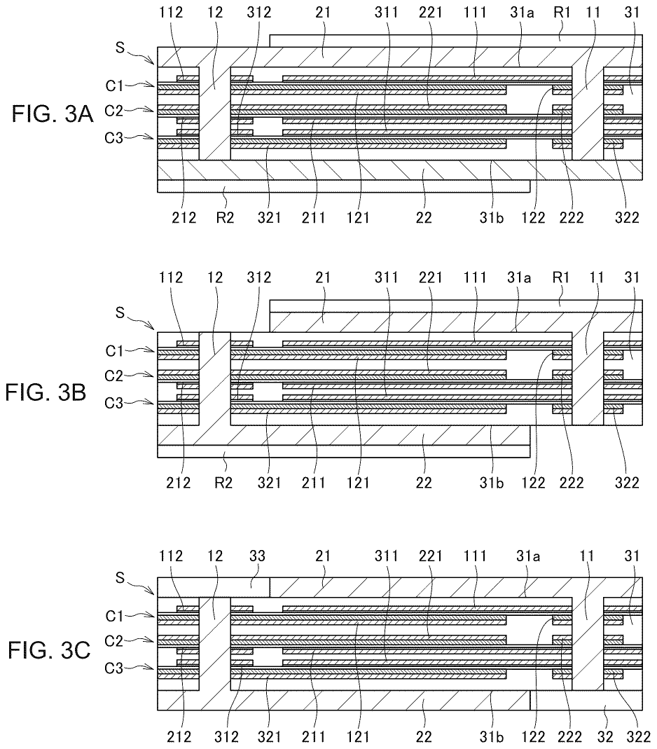

FIGS. 2A to 2D and FIGS. 3A to 3C are process views for explaining a manufacturing method for the thin film capacitor 1 according to the first embodiment.

As illustrated in FIG. 2A, the unit capacitors C1 to C3 are stacked through the insulating layer 31 to form the stacked body S. At this time, the surface 31b (the other outer surface of the stacked body S) of the insulating layer 31 is covered with a conductor pattern 22a. Subsequently, as illustrated in FIG. 2B, laser beam is irradiated onto the stacked body S from the surface 31a side of the insulating layer 31 to form the via hole 11A penetrating the dummy electrodes 122, 222, and 322 and capacitance electrodes 111, 211, and 311 and the via hole 12A penetrating the dummy electrodes 112, 212, and 312 and capacitance electrodes 121, 221, and 321. In the formation process of the via holes 11A and 12A, the conductor pattern 22a functions as a stopper. Subsequently, as illustrated in FIG. 2C, electroless plating is applied to form a seed layer 13 on the surface 31a of the insulating layer 31 and the inner walls of the via holes 11A and 12A, and then electrolytic plating is applied for plating growth of the seed layer 13 as illustrated in FIG. 2D. As a result, the via holes 11A and 12A are filled respectively with via conductors 11 and 12, and the terminal electrode 21 is formed on the surface 31a of the insulating layer 31. Further, the conductor pattern 22a formed on the surface 31b of the insulating layer 31 is grown by plating to form the terminal electrode 22.

Then, as illustrated in FIG. 3A, resist patterns R1 and R2 are respectively formed on the surfaces of the terminal electrodes 21 and 22, and unnecessary portions of the terminal electrodes 21 and 22 are removed by etching with the resist patterns R1 and R2 as masks as illustrated in FIG. 3B, whereby the terminal electrode 21 and the terminal electrode 22 are separated respectively from the via conductor 12 and the via conductor 11. As a result, as illustrated in FIG. 3C, after removal of the resist patterns R1 and R2, the insulating layers 31 and 32 are formed by screen printing or the like, followed by singulation of the thin film capacitor 1 to complete the thin film capacitor 1 according to the present embodiment.

As described above, in the manufacturing process of the thin film capacitor 1 according to the present embodiment, the via holes 11A and 12A are formed to penetrate the stacked body S; however, the via holes 11A and 12A are respectively formed in the dummy areas B1 and B2, so that the effective area A is not damaged in the formation of the via holes 11A and 12A.

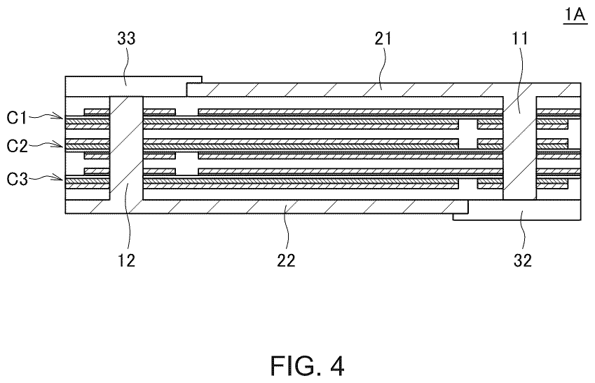

FIG. 4 is a schematic cross-sectional view of a thin film capacitor 1A according to a first modification of the first embodiment.

The thin film capacitor 1A illustrated in FIG. 4 differs from the thin film capacitor 1 according to the first embodiment illustrated in FIGS. 1A to 1C in that the insulating layers 32 and 33 are partially provided on the outer surfaces of the respective terminal electrodes 22 and 21 in an overlapping manner therewith as viewed in the stacking direction. When the terminal electrodes 22 and 21 are partially covered with the insulating layers 32 and 33, the terminal electrodes 21 and 22 become unlikely to be peeled off.

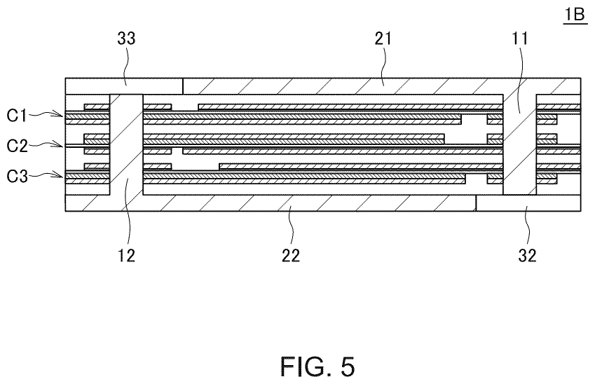

FIG. 5 is a schematic cross-sectional view of a thin film capacitor 1B according to a second modification of the first embodiment.

The thin film capacitor 1B illustrated in FIG. 5 differs from the thin film capacitor 1 according to the first embodiment illustrated in FIGS. 1A to 1C in that the planar positions of the edges of the capacitance electrodes 111, 211, and 311 inside the stacked body S differ from one another and that the planar positions of the edges of the capacitance electrodes 121, 221, and 321 inside the stacked body S differ from one another. With this configuration, even when external stress is applied to the thin film capacitor 1B, stress applied to the edges of the capacitance electrodes 111, 211, and 311 is distributed, and stress applied to the edges of the capacitance electrodes 121, 221, and 321 is distributed. This makes the capacitance electrodes unlikely to be damaged due to external stress.

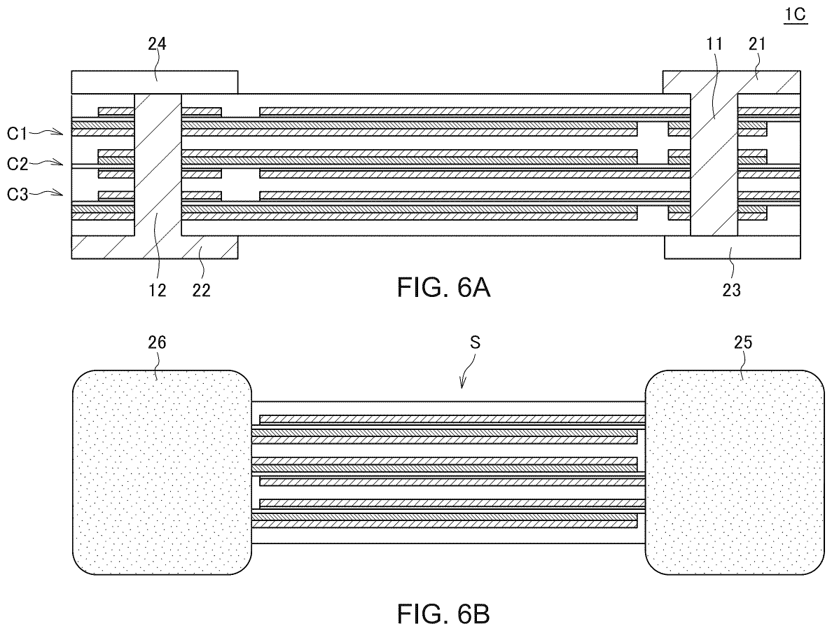

FIG. 6A is a schematic cross-sectional view of a thin film capacitor 1C according to a third modification of the first embodiment.

The thin film capacitor 1C illustrated in FIG. 6A differs from the thin film capacitor 1 according to the first embodiment illustrated in FIGS. 1A to 1C in that the terminal electrodes 21 and 23 are connected to both ends of the via conductor 11 and that the terminal electrodes 22 and 24 are connected to both ends of the via conductor 12. The terminal electrode 23 is provided, in place of the insulating layer 32, on the surface 31b of the insulating layer 31. The terminal electrode 24 is provided, in place of the insulating layer 33, on the surface 31a o the insulating layer 31. This allows access from both sides in the stacking direction. Alternatively, as illustrated in FIG. 6B, when a solder 25 is provided on one side surface of the stacked body S so as to contact the terminal electrodes 21 and 23, and a solder 26 is provided on the other side surface of the stacked body S so as to contact the terminal electrodes 22 and 24, surface mounting on a substrate becomes easy.

### Second Embodiment

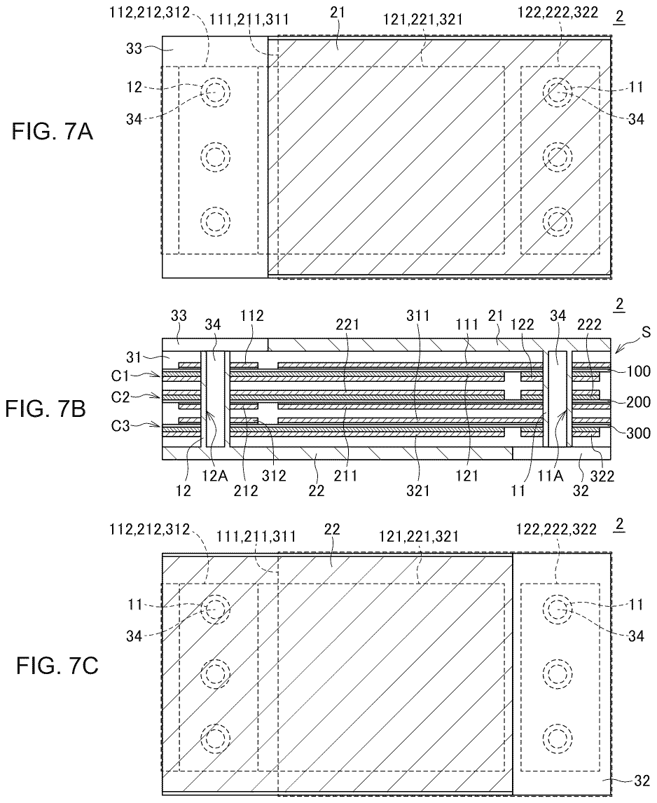

FIG. 7A is a schematic top view of a thin film capacitor 2 according to a second embodiment of the technology described herein as viewed from the upper surface side. FIG. 7B is a schematic cross-sectional view of the thin film capacitor 2. FIG. 7C is a schematic bottom view of the thin film capacitor 2 as viewed from the lower surface side.

The thin film capacitor 2 according to the second embodiment illustrated in FIGS. 7A to 7C differs from the thin film capacitor 1 according to the first embodiment in that the via conductors 11 and 12 are respectively provided on the inner walls of the via holes 11A and 12A and that the center portions of the via holes 11A and 12A surrounded by the via conductors 11 and 12 are filled with a resin member 34. Other basic configurations are the same as those of the thin film capacitor 1 according to the first embodiment, so the same reference numerals are given to the same elements, and overlapping description will be omitted.

The resin member 34 may have an insulating property or a conductive property. Further, the resin member 34 may contain only a resin material or may be obtained by adding an inorganic filler such as silica to a resin material. According to the present embodiment, the thermal expansion coefficients inside the via holes 11A and 12A can be adjusted by the material or volume of the resin member 34, whereby connection reliability of the via conductors 11 and 12 is improved.

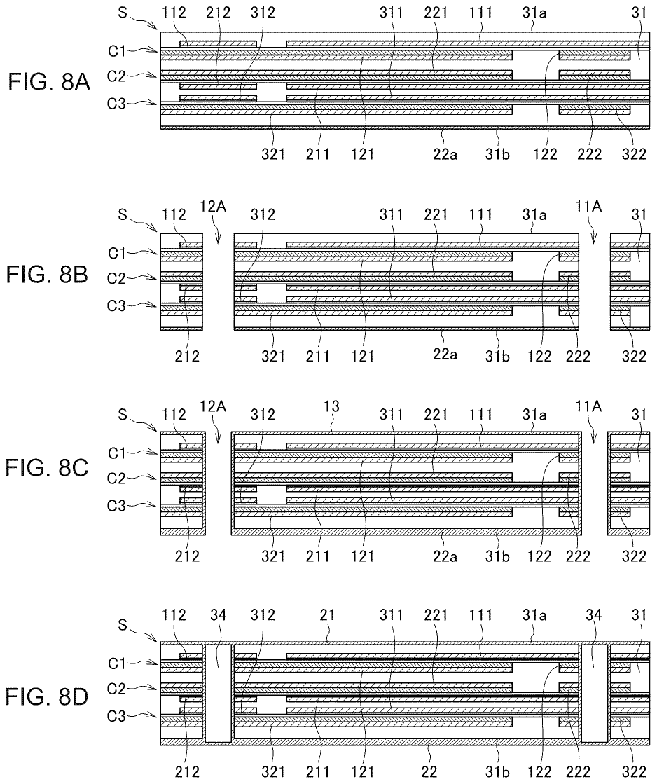

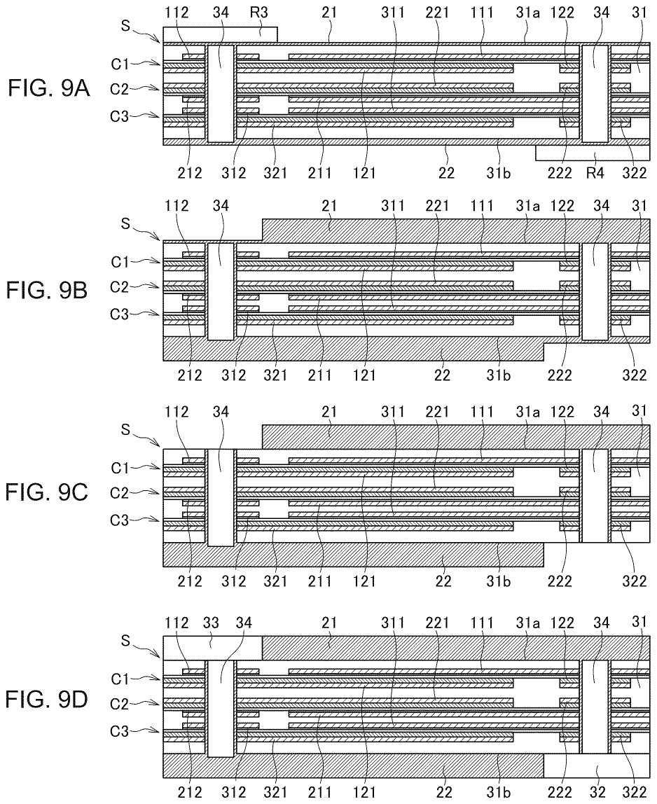

FIGS. 8A to 8D and FIGS. 9A to 9D are process views for explaining a manufacturing method for the thin film capacitor 2 according to the second embodiment.

As illustrated in FIG. 8A, the unit capacitors C1 to C3 are stacked through the insulating layer 31 to form the stacked body S. At this time, the surface 31b (the other outer surface of the stacked body S) of the insulating layer 31 may be covered with a conductor pattern 22a. Subsequently, as illustrated in FIG. 8B, laser beam is irradiated onto the stacked body S to form the via hole 11A penetrating the dummy electrodes 122, 222, and 322 and capacitance electrodes 111, 211, and 311 and the via hole 12A penetrating the capacitance electrodes 121, 221, and 321 and dummy electrodes 112, 212, and 312. Since the surface 31b of the insulating layer 31 is covered with the conductor pattern 22a, the via holes 11A and 12A penetrate the conductor pattern 22a. Subsequently, as illustrated in FIG. 8C, electroless plating is applied to form a seed layer 13 on the surfaces 31a and 31b of the insulating layer 31 and the inner walls of the via holes 11A and 12A, and then the via holes 11A and 12A are filled with the resin member 34 as illustrated in FIG. 8D. After that, additional electroless plating is performed to form the seed layer 13 on the surfaces of the resin member 34 exposed to the end portions of the via holes 11A and 12A. The seed layer 13 formed on the inner walls of the via holes 11A and 12A constitutes the via conductors 11 and 12. After formation of the seed layer 13, electrolytic plating may be performed so as to increase the film thicknesses of the via conductors 11 and 12.

Then, as illustrated in FIG. 9A, resist patterns R3 and R4 are formed in areas where the insulating layers 32 and 33 are to be formed. After that, as illustrated in FIG. 9B, electrolytic plating is performed with the resist patterns R3 and R4 as masks for plating growth of the seed layer 13, whereby the terminal electrodes 21 and 22 are formed respectively on the surface 31a and 31b of the insulating layer 31. Subsequently, after removal of the resist patterns R3 and R4, unnecessary portions of the seed layer 13 are removed as illustrated in FIG. 9C. As a result, the terminal electrode 21 and via conductor 12 are separated from each other, and the terminal electrode 22 and via conductor 11 are separated from each other. Then, as illustrated in FIG. 9D, the insulating layers 32 and 33 are formed by screen printing or the like, followed by singulation of the thin film capacitor 2 to complete the thin film capacitor 2 according to the present embodiment.

As described above, in the manufacturing process of the thin film capacitor 2 according to the present embodiment as well, the via holes 11A and 12A are respectively formed in the dummy areas B1 and B2, so that the effective area A is not damaged in the formation of the via holes 11A and 12A. In addition, the via holes 11A and 12A need not completely be filled with the via conductors 11 and 12, respectively, eliminating the need to perform electrolytic plating for a long time.

### Third Embodiment

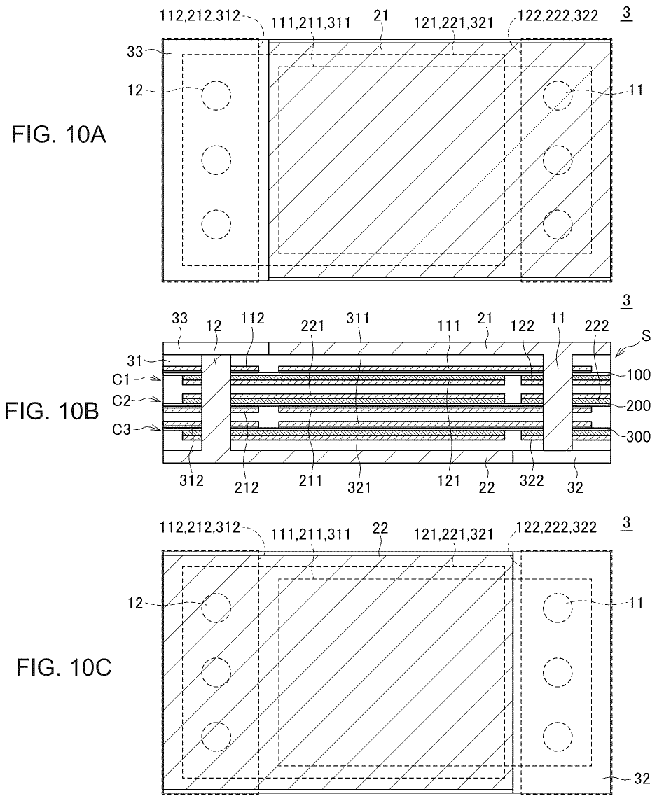

FIG. 10A is a schematic top view of a thin film capacitor 3 according to a third embodiment of the technology described herein as viewed from the upper surface side. FIG. 10B is a schematic cross-sectional view of the thin film capacitor 3. FIG. 10C is a schematic bottom view of the thin film capacitor 3 as viewed from the lower surface side.

The thin film capacitor 3 according to the third embodiment illustrated in FIGS. 10A to 10C differs from the thin film capacitor according to the first embodiment in that the capacitance electrodes 111, 121, 211, 221, 311, and 321 are embedded in the insulating layer 31 without being exposed therefrom and that the dummy electrodes 112, 122, 212, 222, 312, and 322 are exposed at three sides each thereof from the insulating layer 31. That is, the capacitance electrodes 111, 121, 211, 221, 311, and 321 are not exposed from the side surfaces of the stacked body S, while the dummy electrodes 112, 122, 212, 222, 312, and 322 are exposed at three sides each thereof from the stacked body S. Other basic configurations are the same as those of o the thin film capacitor 1 according to the first embodiment, so the same reference numerals are given to the same elements, and overlapping description will be omitted.

In the present embodiment, the capacitance electrodes 111, 121, 211, 221, 311, and 321 are unlikely to be damaged at singulation of the thin film capacitor 3, thus enhancing reliability in the moisture resistance of the effective area A. In the present embodiment, the capacitance electrodes 111, 211, and 311 overlap at three sides each thereof the capacitance electrodes 121, 221, and 321. Thus, the area of the effective area A depends significantly on the areas of the capacitance electrodes 111, 211, and 311.

### Fourth Embodiment

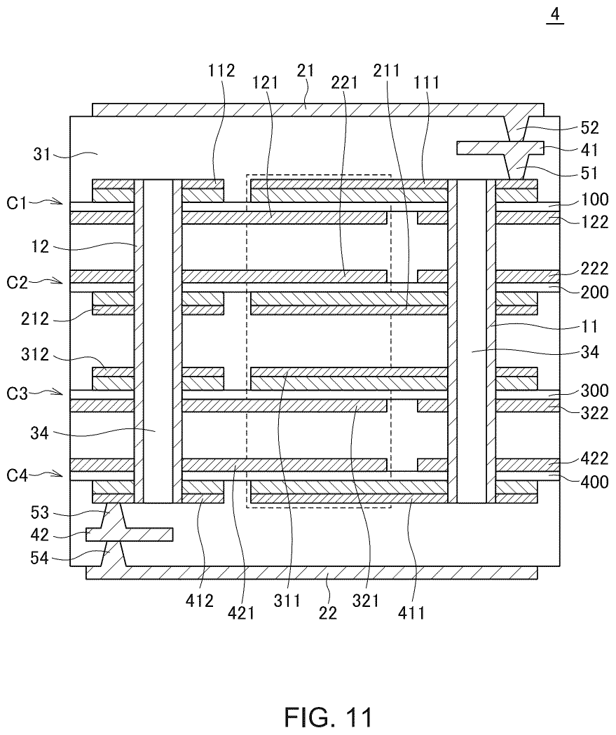

FIG. 11 is a schematic cross-sectional view of a thin film capacitor 4 according to a fourth embodiment of the technology described herein.

The thin film capacitor 4 according to the fourth embodiment illustrated in FIG. 11 has four unit capacitors C1 to C4 stacked to one another. The unit capacitor C4 includes a dielectric layer 400, a capacitance electrode 411 and a dummy electrode 412 which are provided on one surface of the dielectric layer 400, and a capacitance electrode 421 and a dummy electrode 422 which are provided on the other surface of the dielectric layer 400. The via hole 11A is formed so as to penetrate the dummy electrodes 122, 222, 322, and 422 and capacitance electrodes 111, 211, 311, and 411. The via hole 11B is formed so as to penetrate the dummy electrodes 112, 212, 312, and 412 and capacitance electrodes 121, 221, 321, and 421. The via conductor 11 is formed on the inner wall of the via hole 11A, and the center portion of the via hole 11A surrounded by the via conductor 11 is filled with the resin member 34. The via conductor 12 is formed on the inner wall of the via hole 12A, and the center portion of the via hole 12A surrounded by the via conductor 12 is filled with the resin member 34.

Further, in the thin film capacitor 4 according to the fourth embodiment, both end portions of each of the via conductors 11 and 12 are covered with the insulating layer 31. An internal wiring pattern 41 is provided between the surface 31a of the insulating layer 31 and the unit capacitor C1. The internal wiring pattern 41 is connected to the capacitance electrode 111 through a via conductor 51. An internal wiring pattern 42 is provided between the surface 31b of the insulating layer 31 and the unit capacitor C4. The internal wiring pattern 42 is connected to a dummy electrode 412 through a via conductor 53. The terminal electrode 21 is connected to the internal wiring pattern 41 through a via conductor 52, and the terminal electrode 22 is connected to the internal wiring pattern 42 through a via conductor 54. Other basic configurations are the same as those of the thin film capacitor 2 according to the second embodiment, so the same reference numerals are given to the same elements, and overlapping description will be omitted.

As exemplified by the thin film capacitor 4 according to the fourth embodiment, the terminal electrodes 21 and 22 need not directly contact the via conductors 11 and 12, respectively but may be connected thereto through, for example, the internal wiring patterns illustrated in FIG. 11. With this configuration, even when external stress is applied to the terminal electrodes 21 and 22, stress to be transmitted to the via conductors 11 and 12 is relaxed.

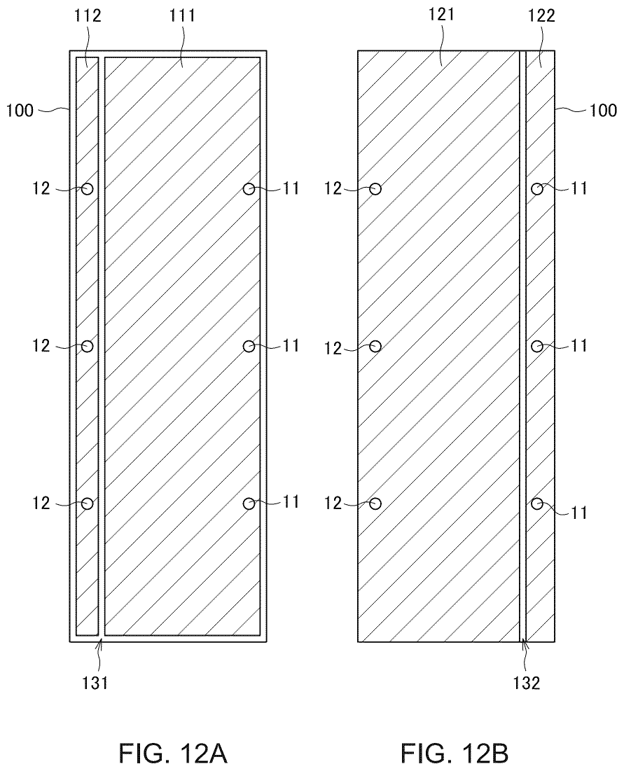

FIGS. 12A and 12B are views for explaining the structure of the unit capacitor C1 according to a first example. FIG. 12A is a schematic top view illustrating the planar shapes of the capacitance electrode 111 and the dummy electrode 112. FIG. 12B is a schematic transparent top view of the planar shapes of the capacitance electrode 121 and the dummy electrode 122 as viewed from the upper surface side.

In the first example illustrated in FIGS. 12A and 12B, the capacitance electrode 111 and dummy electrode 112 are separated from each other by a slit 131, and the capacitance electrode 121 and dummy electrode 122 are separated from each other by a slit 132. The slits 131 and 132 are linear. Three via conductors 12 connected to the capacitance electrodes 121 are allocated to the dummy electrode 112, and three via conductors 11 connected to the capacitance electrodes 111 are allocated to the dummy electrode 122. The capacitance electrode and dummy electrode may thus be separated from each other by a linear slit.

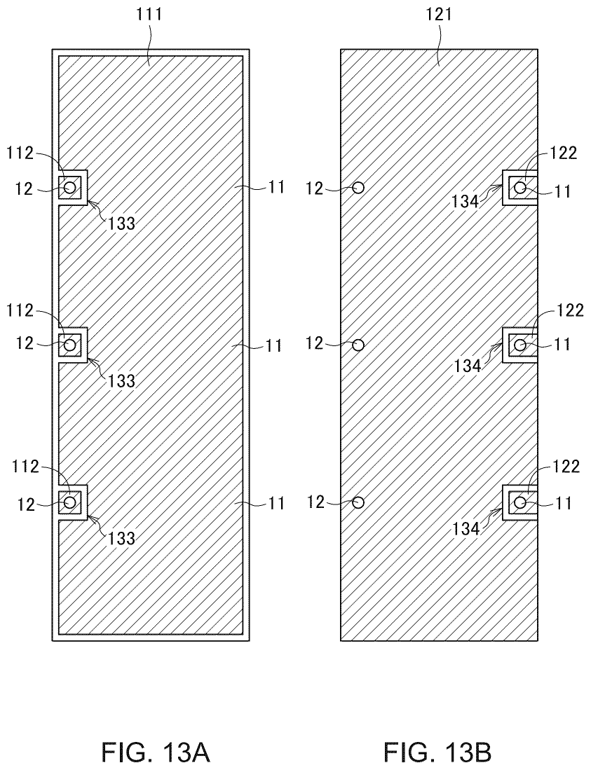

FIGS. 13A and 13B are views for explaining the structure of the unit capacitor C1 according to a second example. FIG. 13A is a schematic top view illustrating the planar shapes of the capacitance electrode 111 and the dummy electrode 112. FIG. 13B is a schematic transparent top view of the planar shapes of the capacitance electrode 121 and the dummy electrode 122 as viewed from the upper surface side.

The second example illustrated in FIGS. 13A and 13B are the same as the first example in terms of the numbers and positions of the via conductors 11 and 12 but differs therefrom in that the dummy electrodes 112 are allocated individually to the via conductors 12 and that the dummy electrodes 122 are allocated individually to the via conductors 11. In the second example, the three dummy electrodes 112 have a rectangular planar shape and are connected with the corresponding via conductors 12 at their substantially center portions. The capacitance electrode 111 and dummy electrode 112 are separated from each other by a substantially U-shaped slit 133. Similarly, the three dummy electrodes 122 have a rectangular planar shape and are connected with the corresponding via conductors 11 at their substantially center portions. The capacitance electrode 121 and dummy electrode 122 are separated from each other by a substantially U-shaped slit 134.

In the second example, a part of the capacitance electrode 111 is positioned between the adjacent dummy electrodes 112, and a part of the capacitance electrode 121 is positioned between the adjacent dummy electrodes 122, so that the effective area A increases in size as compared with the first example. As described above, when the dummy electrodes 112 and 122 are reduced in size, and the capacitance electrodes 111 and 121 are provided so as to surround the dummy electrodes 112 and 122, capacitance can be made larger.

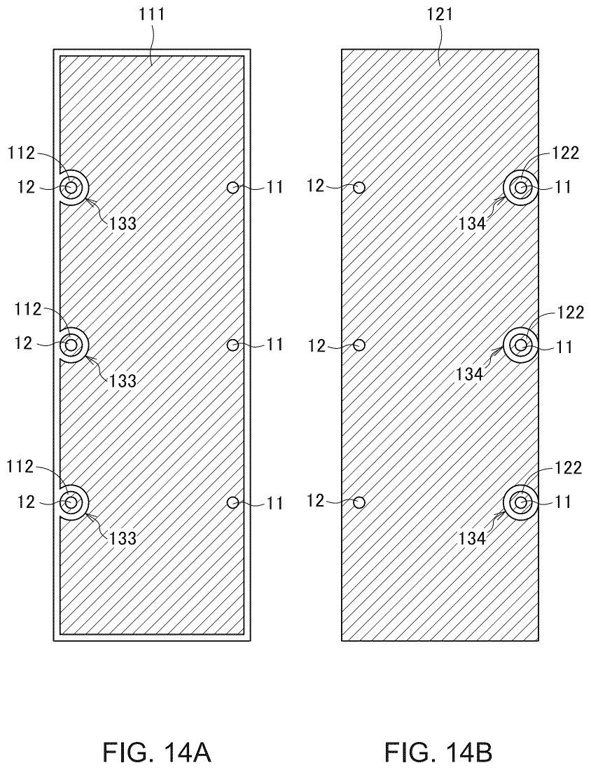

FIGS. 14A and 14B are views for explaining the structure of the unit capacitor C1 according to a third example. FIG. 14A is a schematic top view illustrating the planar shapes of the capacitance electrode 111 and the dummy electrode 112. FIG. 14B is a schematic transparent top view of the planar shapes of the capacitance electrode 121 and the dummy electrode 122 as viewed from the upper surface side.

The third example illustrated in FIGS. 14A and 14B differs from the second example in that the dummy electrodes 112 and 122 have a circular planar shape and are connected with the corresponding via conductors 12 and 11 at their substantially center portions. Thus, the planar shapes of the dummy electrodes 112 and 122 need not necessarily be rectangular but may be circular. This can make the areas of the capacitance electrodes 111 and 121 larger, allowing a larger capacitance to be obtained.

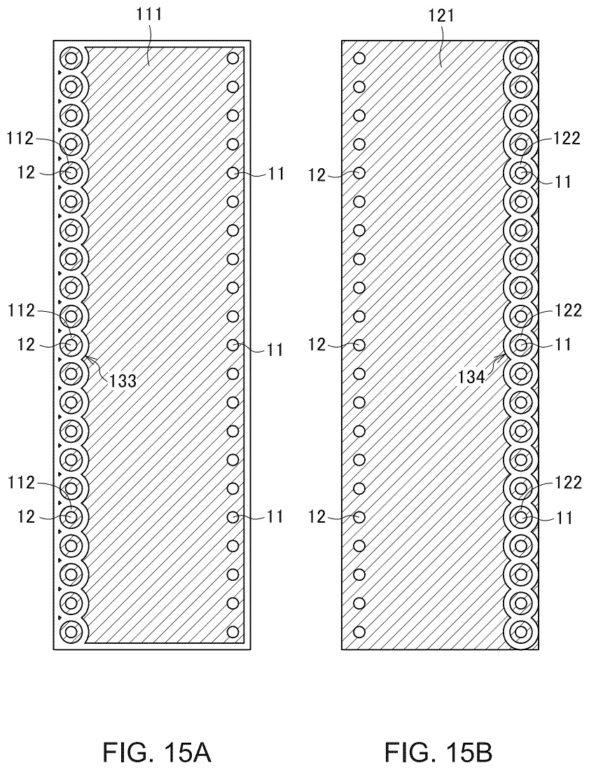

FIGS. 15A and 15B are views for explaining the structure of the unit capacitor C1 according to a fourth example. FIG. 15A is a schematic top view illustrating the planar shapes of the capacitance electrode 111 and the dummy electrode 112. FIG. 15B is a schematic transparent top view of the planar shapes of the capacitance electrode 121 and the dummy electrode 122 as viewed from the upper surface side.

The fourth example illustrated in FIGS. 15A and 15B differs from the third example in that the dummy electrodes 112 and 122 are successively provided in large numbers. Thus, when the dummy electrodes 112 and 122 are provided in large numbers, the numbers of the via conductors 11 and 12 increase correspondingly, so that a combined resistance value of the via conductors 11 and 12 can be reduced.

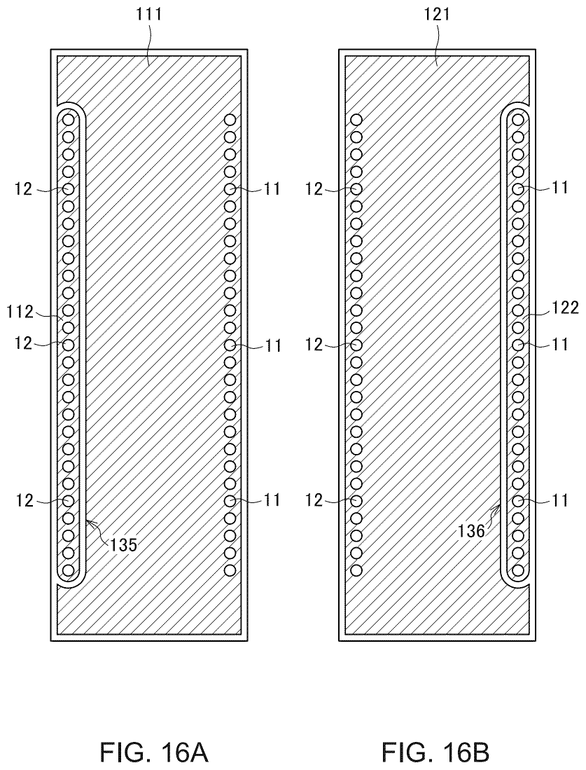

FIGS. 16A and 16B are views for explaining the structure of the unit capacitor C1 according to a fifth example. FIG. 16A is a schematic top view illustrating the planar shapes of the capacitance electrode 111 and the dummy electrode 112. FIG. 16B is a schematic transparent top view of the planar shapes of the capacitance electrode 121 and the dummy electrode 122 as viewed from the upper surface side.

In the fifth example illustrated in FIGS. 16A and 16B, the via conductors 11 and 12 are provided in large numbers, one dummy electrode 112 is allocated to the large number of via conductors 12, and one dummy electrode 122 is allocated to the large number of via conductors 11. This reduces the area to be allocated to a slit 135 for separating the capacitance electrode 111 and dummy electrode 112 and the area to be allocated to a slit 136 for separating the capacitance electrode 121 and dummy electrode 122, whereby it is possible to ensure sufficient capacitance while reducing a combined resistance value of the via conductors 11 and 12.

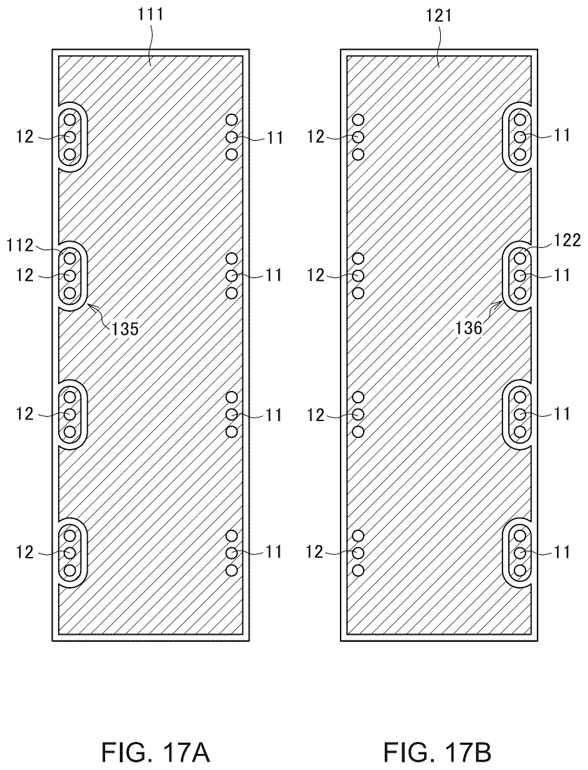

FIGS. 17A and 17B are views for explaining the structure of the unit capacitor C1 according to a sixth example. FIG. 17A is a schematic top view illustrating the planar shapes of the capacitance electrode 111 and the dummy electrode 112. FIG. 17B is a schematic transparent top view of the planar shapes of the capacitance electrode 121 and the dummy electrode 122 as viewed from the upper surface side.

In the sixth example illustrated in FIGS. 17A and 17B, four dummy electrodes 112 are provided, each of which has three via conductors 12, and four dummy electrodes 122 are provided, each of which has three via conductors 11. This can achieve larger capacitance than in the fifth example.

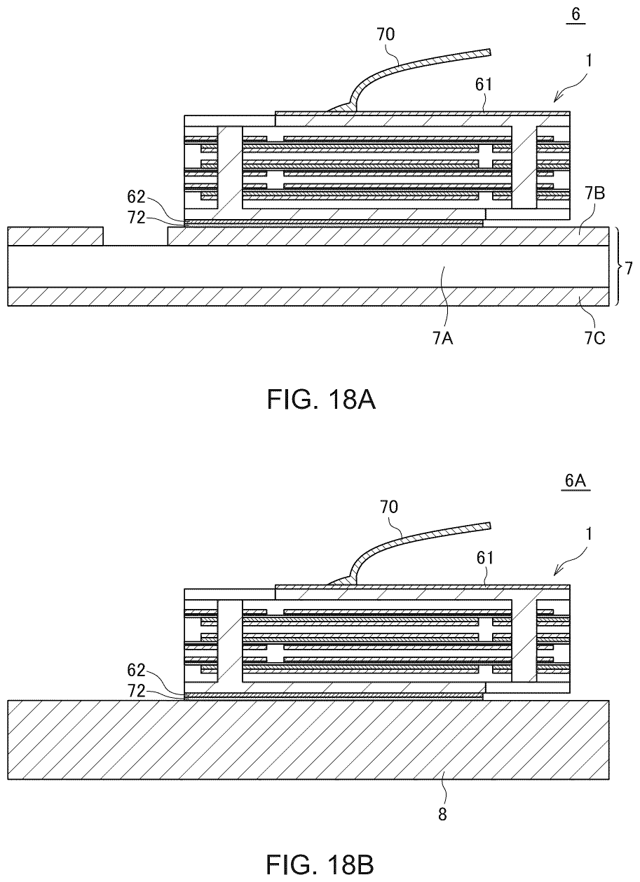

FIG. 18A is a schematic cross-sectional view for explaining the structure of a circuit board 6 having the thin film capacitor 1 according to the first embodiment.

The circuit board 6 illustrated in FIG. 18A has a DBC (Direct Bonded Copper) substrate 7 and the thin film capacitor 1 mounted on the DBC substrate 7. The DBC substrate 7 has a substrate body part 7A made of an insulating material having a high heat conductivity, such as Al₂O₃, AlN, or Si₃N₄ and metal conductor patterns 7B and 7C formed on the front and back surfaces of the substrate body part 7A. The conductor patterns 7B and 7C are made of copper (Cu), for example. In the example illustrated in FIG. 18A, the thin film capacitor 1 is mounted on the DBC substrate 7 such that the terminal electrode 22 of the thin film capacitor 1 is connected to the conductor pattern 7B of the DBC substrate 7.

The surfaces of the terminal electrodes 21 and 22 of the thin film capacitor 1 are covered respectively with surface treatment films 61 and 62 each containing gold (Au), tin (Sn), and the like. The surface treatment film 62 of the thin film capacitor 1 and the conductor pattern 7B of the DBC substrate 7 are connected to each other through a solder 72. Examples of the material of the solder 72 may include AuSn, AgSn, PbSn, SnSb, SnCu, SnCuNi, SnCuAg, SnCuBiIn, SnNiPCuGa, SmAgBiCu, SnAgBiCuIn, SnInAgBi, SnZn, SnZnBi, SnIn, and SnBi. The surface treatment film 61 of the thin film capacitor 1 is connected with a bonding wire 70. When the thin film capacitor 1 is thus mounted on the DBC substrate 7, heat generated by the thin film capacitor 1 is efficiently dissipated through the DBC substrate 7.

FIG. 18B is a schematic cross-sectional view for explaining the structure of a circuit board 6A having the thin film capacitor 1 according to the first embodiment.

The circuit board 6A illustrated in FIG. 18B differs from the circuit board 6 illustrated in FIG. 18A in that it uses a metal block 8 made of, for example, copper (Cu) in place of the DBC substrate 7. The surface treatment film 62 of the thin film capacitor 1 and the metal block 8 are connected to each other through the solder 72. As set forth, it is possible to replace the DBC substrate 7 with the metal block 8 made of, for example, copper (Cu), on which the thin film capacitor 1 is mounted.

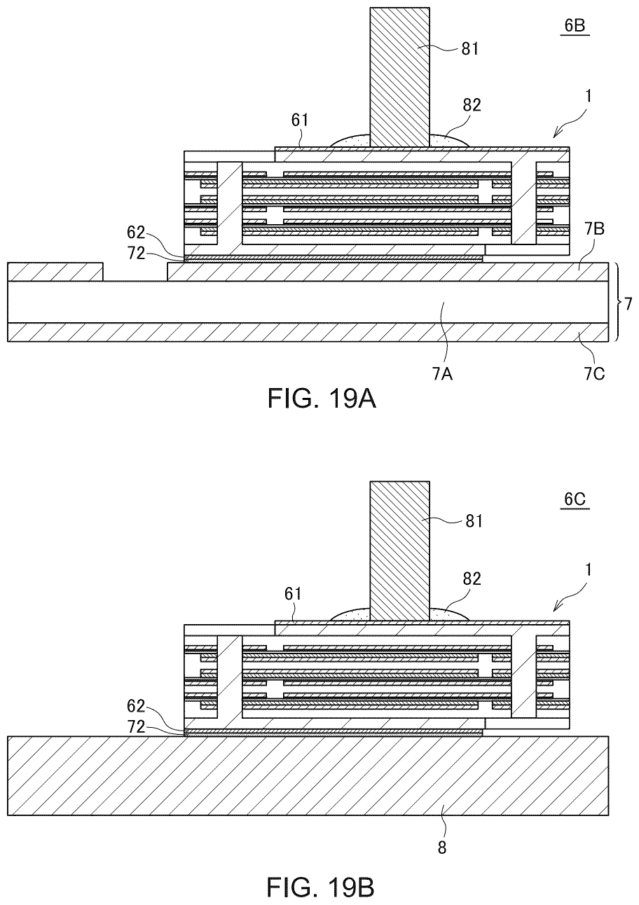

FIG. 19A is a schematic cross-sectional view for explaining the structure of a circuit board 6B having the thin film capacitor 1 according to the first embodiment.

The circuit board 6B illustrated in FIG. 19A differs from the circuit board 6 illustrated in FIG. 18A in that it uses a metal pillar 81 in place of the bonding wire 70. The metal pillar 81 and the surface treatment film 61 on the terminal electrode 21 are connected to each other through a solder 82. As described above, the metal pillar 81 may be used in place of the bonding wire 70.

FIG. 19B is a schematic cross-sectional view for explaining the structure of a circuit board 6C having the thin film capacitor 1 according to the first embodiment.

The circuit board 6C illustrated in FIG. 19B differs from the circuit board 6B illustrated in FIG. 19A in that it uses the metal block 8 in place of the DBC substrate 7. Thus, even when the metal pillar 81 is used, it is possible to use the metal block 8 made of copper (Cu) in place of the DBC substrate 7.

While the preferred embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

A thin film capacitor according to an aspect of the present disclosure includes: a plurality of unit capacitors stacked to one another through a first insulating layer; and first and second via conductors. Each of the plurality of unit capacitors includes a dielectric layer having opposing first and second surfaces, a first capacitance electrode and a first dummy electrode which are provided on the first surface of the dielectric layer, and a second capacitance electrode and a second dummy electrode which are provided on the second surface of the dielectric layer. The first capacitance electrode overlaps with the second capacitance electrode and the second dummy electrode. The second capacitance electrode overlaps with the first capacitance electrode and the first dummy electrode. The first via conductor penetrates the plurality of unit capacitors and the first insulating layer so as to contact the first capacitance electrode and the second dummy electrode included in each of the plurality of unit capacitors, and the second via conductor penetrates the plurality of unit capacitors and the first insulating layer so as to contact the second capacitance electrode and the first dummy electrode included in each of the plurality of unit capacitors. With this configuration, it is possible to make capacitance larger in accordance with the number of the unit capacitors and to make an effective area where the first and second capacitance electrodes overlap each other unlikely to be damaged.

In the above thin film capacitor, the first capacitance electrodes included in the unit capacitors adjacent to each other in the stacking direction may face each other. This can suppress generation of stray capacitance.

In the above thin film capacitor, the edges of the first capacitance electrodes included in the unit capacitors adjacent to each other in the stacking direction may differ in planar position from each other. This makes the first capacitance electrodes unlikely to be damaged due to external stress.

The above thin film capacitor may further have a first terminal electrode which is provided on one surface of the first insulating layer so as to be connected to one end portion of the first via conductor and a second terminal electrode which is provided on the other surface of the first insulating layer so as to be connected to one end portion of the second via conductor. As a result, the first capacitance electrode and first terminal electrode are connected to each other at a low resistance, and the second capacitance electrode and second terminal electrode are connected to each other at a low resistance.

In the above thin film capacitor, each of the first and second via conductors may be provided in plural numbers, the plurality of first via conductors may be connected in common to the first terminal electrode, and the plurality of second via conductors may be connected in common to the second terminal electrode. This can reduce a connection resistance between the unit capacitors and the first and second terminal electrodes.

The above thin film capacitor may further have a second insulating layer which is provided on the other outer surface of the first insulating layer so as to contact the other end portion of the first via conductor, and a third insulating layer which is provided on the one outer surface of the first insulating layer SO as to contact the other end portion of the second via conductor. This can insulate the other end portions of the first and second via conductors.

In the above thin film capacitor, a part of the second insulating layer may be provided on the outer surface of the second terminal electrode so as to overlap the second terminal electrode in the stacking direction, and a part of the third insulating layer may be provided on the outer surface of the first terminal electrode so as to overlap the first terminal electrode in the stacking direction. This can prevent peeling of the first and second terminal electrodes.

In the above thin film capacitor, the first terminal electrode may contact both the one and the other end portions of the first via conductor, and the second terminal electrode may contact both the one and the other end portions of the second via conductor. This allows access to the first and second terminal electrodes from both sides in the stacking direction.

In the above thin film capacitor, the first and second capacitance electrodes may overlap each other at a position between the first and second via conductors in a plan view. This enhances the moisture resistance of the effective area where the first and second capacitance electrodes overlap each other, which increases product reliability.

In the above thin film capacitor, the first and second via conductors may be filled in via holes each penetrating the plurality of unit capacitors and the first insulating layer. This reduces resistance values of the first and second via conductors.

In the above thin film capacitor, the first and second via conductors may be provided on the inner walls of via holes each penetrating the plurality of unit capacitors and the first insulating layer, and the center portions of the via holes surrounded by the first and second via conductors may be filled with a resin member. This allows the thermal expansion coefficient inside the via hole to be adjusted by the material or volume of the resin member.

In the above thin film capacitor, the first and second capacitance electrodes may be embedded in the first insulating layer without being exposed from the first insulating layer. This makes the first and second capacitance electrodes unlikely to be damaged at singulation.

In the above thin film capacitor, the first dummy electrode may be surrounded by the first capacitance electrode at least in three directions, and the second dummy electrode may be surrounded by the second capacitance electrode at least in three directions. This can make the areas of the first and second capacitance electrodes larger. A circuit board according to an aspect of the present disclosure includes: a substrate having surfaces from which a metal member is exposed and the above-described thin film capacitor. The thin film capacitor is mounted on the substrate such that the first terminal electrode is connected to the metal member. This allows heat generated by the thin film capacitor to be dissipated efficiently through the substrate.

### REFERENCE SIGNS LIST

1-4, 1A, 1B, 1C thin film capacitor
6, 6A, 6B, 6C circuit board
7 DBC substrate
7A substrate body part
7B, 7C conductor pattern
8 metal block
11, 12 via conductor
11A, 12A via hole
13 seed layer
21-24 terminal electrode
22a conductor pattern
25, 26 solder
31-33 insulating layer
31a, 31b surface
34 resin member
41, 42 internal wiring pattern
51-54 via conductor
61, 62 surface treatment film
70 bonding wire
72 solder
81 metal pillar
82 solder
100, 200, 300, 400 dielectric layer
101, 102, 201, 202, 301, 302 surface
111, 121, 211, 221, 311, 321, 411, 421 capacitance electrode
112, 122, 212, 222, 312, 322, 412, 422 dummy electrode
131-136 slit
1111, 1121, 1211, 1221 lower layer conductor
1112, 1122, 1212, 1222 upper layer conductor
A effective area
B1, B2 dummy area
C1-C4 unit capacitor
R1-R4 resist pattern
S stacked body

1. A thin film capacitor comprising:
a plurality of unit capacitors stacked to one another through a first insulating layer; and
first and second via conductors,
wherein each of the plurality of unit capacitors includes a dielectric layer having opposing first and second surfaces, a first capacitance electrode and a first dummy electrode which are provided on the first surface of the dielectric layer, and a second capacitance electrode and a second dummy electrode which are provided on the second surface of the dielectric layer,
wherein the first capacitance electrode overlaps with the second capacitance electrode and the second dummy electrode,
wherein the second capacitance electrode overlaps with the first capacitance electrode and the first dummy electrode,
wherein the first via conductor penetrates the plurality of unit capacitors and the first insulating layer so as to contact the first capacitance electrode and the second dummy electrode included in each of the plurality of unit capacitors, and
wherein the second via conductor penetrates the plurality of unit capacitors and the first insulating layer so as to contact the second capacitance electrode and the first dummy electrode included in each of the plurality of unit capacitors.

2. The thin film capacitor as claimed in claim 1, wherein the first capacitance electrodes included in the unit capacitors adjacent to each other in a stacking direction face each other.

3. The thin film capacitor as claimed in claim 2, wherein edges of the first capacitance electrodes included in the unit capacitors adjacent to each other in the stacking direction differ in planar position from each other.

4. The thin film capacitor as claimed in claim 1, further comprising:
a first terminal electrode which is provided on one surface of the first insulating layer so as to be connected to one end portion of the first via conductor; and
a second terminal electrode which is provided on other surface of the first insulating layer so as to be connected to one end portion of the second via conductor.

5. The thin film capacitor as claimed in claim 4,
wherein each of the first and second via conductors is provided in plural numbers,
wherein the plurality of first via conductors are connected in common to the first terminal electrode, and
wherein the plurality of second via conductors are connected in common to the second terminal electrode.

6. The thin film capacitor as claimed in claim 4, further comprising:
a second insulating layer which is provided on the other outer surface of the first insulating layer so as to contact other end portion of the first via conductor; and
a third insulating layer which is provided on the one outer surface of the first insulating layer so as to contact other end portion of the second via conductor.

7. The thin film capacitor as claimed in claim 6,
wherein a part of the second insulating layer is provided on an outer surface of the second terminal electrode so as to overlap the second terminal electrode in a stacking direction, and
wherein a part of the third insulating layer is provided on an outer surface of the first terminal electrode so as to overlap the first terminal electrode in the stacking direction.

8. The thin film capacitor as claimed in claim 4,
wherein the first terminal electrode contacts both the one and other end portions of the first via conductor, and
wherein the second terminal electrode contacts both the one and other end portions of the second via conductor.

9. The thin film capacitor as claimed in claim 1, wherein the first and second capacitance electrodes overlap each other at a position between the first and second via conductors in a plan view.

10. The thin film capacitor as claimed in claim 1, wherein the first and second via conductors are filled in via holes each penetrating the plurality of unit capacitors and the first insulating layer.

11. The thin film capacitor as claimed in claim 1,
wherein the first and second via conductors are provided on inner walls of via holes each penetrating the plurality of unit capacitors and the first insulating layer, and
wherein center portions of the via holes surrounded by the first and second via conductors are filled with a resin member.

12. The thin film capacitor as claimed in claim 1, wherein the first and second capacitance electrodes are embedded in the first insulating layer without being exposed from the first insulating layer.

13. The thin film capacitor as claimed in claim 1,
wherein the first dummy electrode is surrounded by the first capacitance electrode at least in three directions, and
wherein the second dummy electrode is surrounded by the second capacitance electrode at least in three directions.

14. A circuit board comprising:
a substrate having surfaces from which a metal member is exposed; and
the thin film capacitor as claimed in claim 4,
wherein the thin film capacitor is mounted on the substrate such that the first terminal electrode is connected to the metal member.
